(19) United States
(12) Patent Application Publication
(10) Pub. No.: US 2026/0246767 A1
(43) Pub. Date: Aug. 20, 2026

(54) SYSTEMS AND METHODS FOR AUTOMATICALLY AND DYNAMICALLY AUTHENTICATING USERS USING END-DEVICE ARTIFICIAL INTELLIGENCE

(71) Applicant: BANK OF AMERICA CORPORATION, Charlotte, NC (US)

(72) Inventors: Christine D. Black, Brooksville, ME (US); Vinicius Da Costa, Charlotte, NC (US); Jinna Kim, Charlotte, NC (US); Sanjay Lohar, Mint Hill, NC (US)

(73) Assignee: BANK OF AMERICA CORPORATION, Charlotte, NC (US)

(21) Appl. No.: 19/054,257

(22) Filed: Feb. 14, 2025

(51) Int. Cl. H04L 9/40

(52) U.S. Cl. CPC H04L 63/08

(57) ABSTRACT

Systems, computer program products, and methods are described herein for automatically and dynamically authenticating users using end-device artificial intelligence. The present disclosure is configured to identify, in real time, user data at a user device; analyze, by an artificial intelligence (AI) engine stored on the user device, the user data; determine, by the AI engine, a current user of the user device based on the analysis of the user data; determine, by the AI engine, whether the current user is a known user based on the analysis of the user data; and generate, by the AI engine, a response based on the determination of whether the current user is a known user.

### TECHNOLOGICAL FIELD

The present disclosure is related generally to automatically and dynamically authenticating users using end-device artificial intelligence and, more specifically, implementing artificial intelligence (AI) that is stored on a user device to analyze user data to determine the user of the user device and generate a response verifying the user's identity.

### BACKGROUND

User authentication, in the current environment, may require a user device to transmit the personal information of users across networks to other remote servers, devices, data centers, and the like, where the personal information is actually verified. Such transmission may pose various data security concerns. Data may be lost in transit, for example. The transmissions may be subject to cyberattacks and hackers may try to intercept the data. Further, the remote server, device, or data center to which the data may be transmitted may not be secure. Finally, user authentication may be required by various applications or entities for various products or services and may be required every time such product or service is being accessed, for example. Users'personal data may, therefore, be sent to various different remote servers, devices or data centers, numerous times each, significantly multiplying the data security concerns.

Applicant has identified a number of deficiencies and problems associated with remote user authentication. Therefore, a need exists to develop systems, computerized methods, computer program products and the like that authenticates users without the significant data security concerns that come with transmitting personal information across networks. Through applied effort, ingenuity, and innovation, many of these identified problems have been solved by developing solutions that are included in embodiments of the present disclosure, many examples of which are described in detail herein.

### BRIEF SUMMARY

The following a simplified summary of one or more embodiments of the disclosure in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present disclosure provide for systems, methods, computer program products and the like that provide for automatically and dynamically authenticating users using end-device artificial intelligence. Specifically, the disclosure provides for identifying, in real time, user data at a user device. In some embodiments, the user data is identified via at least one of the user device and one or more connected devices. The one or more connected devices are devices associated with the known user. Then, an artificial intelligence (AI) engine that is stored on the user device, analyzes the user data. Analyzing the user data may comprise comparing the user data to historical user data. The AI engine then determines a current user of the user device and whether the current user is a known user based on the analysis of the user data. Based on the determination of whether the current user is a known user, the AI engine generates a response. In some embodiments, the disclosure provides for receiving a request for authentication from a requesting system, determining, by the AI engine, the current user at a specific time and transmitting the response to the requesting system. In some embodiments, the specific time is the time at which the request for authentication was received. In some embodiments, the requesting system is remote from the user device.

In some embodiments of the disclosure the AI engine is isolated from other applications within the user device and the AI engine can only transmit the response out of the system. In some embodiments of the disclosure, the AI engine determines whether the user data was generated by or using artificial intelligence. In some embodiments of the disclosure, the AI engine detects a change in the current user during a specific log-in period, generates an updated response upon detection of the change, and transmits the updated response to the requesting system.

In some embodiments of the disclosure the response triggers one or more actions. One of the one or more actions comprises launching a secondary authentication method. In some embodiments, the response comprises one of the following responses: yes, no, or maybe. ‘Yes’ is a response indicating the current user is the known user. ‘No’ is a response indicating the current user is not the known user. ‘Maybe’ is a response indicating the current user may or may not be the known user. In some embodiments, the response comprises a threat score.

As such, the present disclosure provides for automatically and dynamically authenticating users using end-device artificial intelligence, such that users'personal information is not transmitted across networks or to other entities, thereby minimizing data security concerns.

A system for automatically and dynamically authenticating users using end-device artificial intelligence defines first embodiments of the disclosure. The system comprises a memory device comprising non-transitory computer-readable medium with computer-readable program code stored thereon. The system further comprises at least one processing device operatively couples to the at least one memory device and at least one communication device. When executed, the computer-readable code is configured to cause the at least one processing device to identify, in real time, user data at a user device; analyze, by an artificial intelligence (AI) engine stored on the user device, the user data, wherein analyzing the user data comprises comparing the user data to historical user data; determine, by the AI engine, a current user of the user device based on the analysis of the user data; determine, by the AI engine, whether the current user is a known user based on the analysis of the user data; and generate, by the AI engine, a response based on the determination of whether the current user is a known user.

In some embodiments of the disclosure, the computer readable code is further configured to cause the at least one processing device to receive a request for authentication from a requesting system; determine, by the AI engine, the current user at a specific time, wherein the specific time is a time at which the request for authentication was received; and transmit the response to the requesting system. In some embodiments, the requesting system is remote from the user device.

In some embodiments of the disclosure, the system is isolated from other applications within the user device. In some embodiments, the system can only transmit the response out of the system.

In some embodiments of the disclosure, the computer-readable code is further configured to cause the at least one processing device to determine, by the AI engine, whether the user data was generated by or using artificial intelligence.

In some embodiments of the disclosure, the computer-readable code is further configured to cause the at least one processing device to detect, by the AI engine, a change in the current user during a specific log-in period; generate, by the AI engine, an updated response upon detection of the change; and transmit, by the AI engine, the updated response to the requesting system.

In some embodiments of the disclosure the user data is identified via at least one of the user device and one or more connected devices, wherein the one or more connected devices are devices associated with the known user.

In some embodiments of the disclosure, the computer-readable code is further configured to cause the at least one processing device to trigger one or more actions based on the response, wherein one of the one or more actions comprises launching a secondary authentication method. In some embodiments, the response comprises one of the following responses: yes, wherein the yes is a response indicating the current user is the known user; no, wherein the no is a response indicating the current user is not the known user; or maybe, wherein the maybe is a response indicating the current user may or may not be the known user. In some embodiments, the response comprises a threat score.

Similarly, and as a person of skill in the art will understand, each of the features, functions, and advantages provided herein with respect to the system disclosed herein above may additionally be provided with respect to a computer-implemented method and computer program product. Such embodiments are provided for exemplary purposes below and are not intended to be limited.

Thus, according to embodiments of the disclosure, which will be discussed in greater detail below, the present disclosure provides for automatically and dynamically authenticating users using end-device artificial intelligence to minimize data security concerns. Specifically, the disclosure provides for identifying user data, analyzing the user data, determining a current user of a user device and whether the current user is a known user based on the analysis of the user data, and generating a response based on the determination of whether the current user is a known user. In some embodiments, an AI engine analyzes the user data, determines the current user and whether the current user is a known user, and generates the response. In some embodiments, the user data may be identified via the user device and/or one or more connected devices. In some embodiments, the disclosure further provides for receiving a request for authentication from a requesting system, determining the current user at the time the request is received and transmitting the response to the requesting system. In some embodiments, the requesting system is remote from the user device. In some embodiments, the AI engine detects a change in the current user during a specific log-in period after authentication, generates an updated response upon detection of the change, and transmits the updated response to the requesting system. In some embodiments, one or more actions are triggered based on the response, such as launching a secondary authentication method. In some embodiments, the response comprises one of yes, no, or maybe, and in some embodiments, the response comprises a threat score. In some embodiments of the disclosure, the AI engine is isolated from other applications within the user device and the AI engine can only transmit the response out of the system. In some embodiments of the disclosure, the AI engine determines whether the user data was generated by or using artificial intelligence.

The above summary is provided merely for purposes of summarizing some example embodiments to provide a basic understanding of some aspects of the present disclosure. The features, functions, and advantages that have been discussed may be achieved independently in various embodiments of the present disclosure or may be combined with yet other embodiments, further details of which can be seen with reference to the following description and drawings. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically and dynamically authenticating users using end-device artificial intelligence, in accordance with an embodiment of the disclosure;

FIG. 2 illustrates an exemplary artificial intelligence (AI) subsystem architecture, in accordance with an embodiment of the disclosure;

FIG. 3 illustrates a process flow for automatically and dynamically authenticating users using end-device artificial intelligence, in accordance with an embodiment of the disclosure;

FIG. 4 illustrates a process flow for receiving and responding to requests for authentication, in accordance with an embodiment of the disclosure; and

FIG. 5 illustrates a process flow for monitoring for a change in the user after authentication, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As will be appreciated by one of skill in the art in view of this disclosure, the present disclosure may be embodied as a system, a method, a computer program product or a combination of the foregoing. Accordingly, embodiments of the present disclosure may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present disclosure may take the form of a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present disclosure may be written in an object oriented, scripted or unscripted programming language such as JAVA, PERL, SMALLTALK, C++, PYTHON or the like. However, the computer program code/computer-readable instructions for carrying out operations of the disclosure may also be written in conventional procedural programming languages, such as the “C” programming language or similar programming languages.

Embodiments of the present disclosure are described below with reference to flowchart illustrations and/or block diagrams of method or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the disclosure.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “satisfying the threshold” or “meeting the threshold” may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

According to embodiments of the disclosure, which will be described in more detail below, systems, methods and computer program products are disclosed that provide for automatically and dynamically authenticating users using end-device artificial intelligence. Specifically, the disclosure provides for authenticating users using an artificial intelligence engine stored on the user device and transmitting only a response indicating whether or not the user's identity has been verified.

User authentication may give rise to various data security concerns because user authentication usually entails transmitting user data, which may comprise personal or sensitive data, across networks to be verified. A user may require user authentication multiple times for multiple purposes throughout a day. Each time, the user's information may have to be transmitted to a different application, network, server or system for the user to be authenticated. The more the user's information is transmitted, and the more networks, systems, or entities receive the user's information, the higher the likelihood that the user's information may be compromised.

Authenticating the user at the end-device alleviates a lot of such data security concerns. Authenticating the user locally, at the user's end-device, using the user's information at the end-device, may avoid having to transmit any of the user's information across networks, thus minimizing data security concerns associated with such transmission. Such end-device authentication may also drastically reduce the number of entities, networks or systems to which the user's information is sent, thereby alleviating some of the data security concerns that come with such distribution of data.

Accordingly, the present disclosure provides for an artificial intelligence (AI) engine that analyzes user data identified in real time, determines the current user of the user device and whether the current user is a known user, and generates a response based on whether the current user is the known user. In some embodiments, user data may be identified via the user device or one or more connected devices. In some embodiments, the AI engine may determine whether user data was AI-generated. In some embodiments, the AI engine analyzes user data by comparing the user data to historical user data. In some embodiments, the response may comprise one of the following: yes, no, or maybe. In some embodiments, the response may comprise a flexible threat score. In some embodiments, the response can trigger one or more actions, such as a secondary authentication method. In some embodiments, the AI engine may receive a request for authentication from a requesting system, determine the current user at the time the request is received and transmit a response based on whether that current user is the known user. In some embodiments, the requesting system is remote from the user device. In some embodiments the AI engine can detect a change in the current user and transmit an updated response. In some embodiments, the system can only transmit the response. In some embodiments, the AI engine is isolated from other applications within the user device.

What is more, the present disclosure provides a technical solution to a technical problem. As described herein, the technical problem includes data security concerns associated with transmitting user data across networks or devices for user authentication. The technical solution presented herein allows for local user authentication at the end-device using artificial intelligence that does not require transmitting any user data, such that the user data remains secure on the end-device. In particular, using artificial intelligence to authenticate users at the end-device is an improvement over existing solutions to transmitting users'personal information for user authentication, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

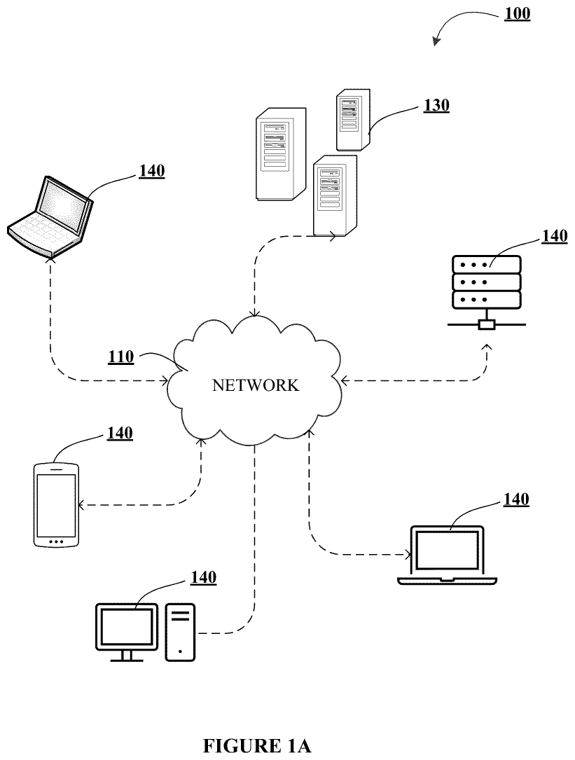

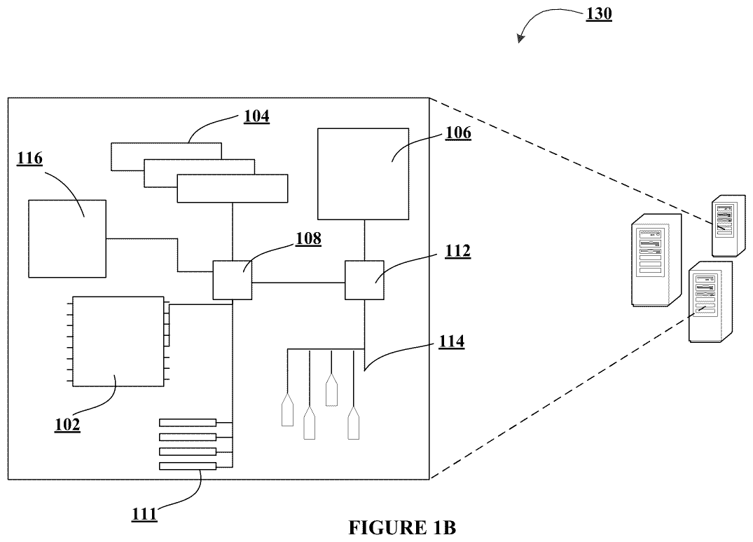

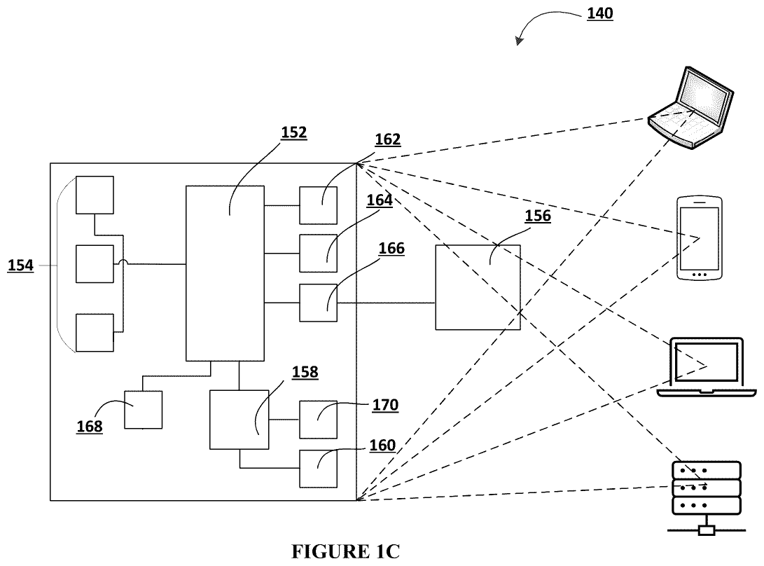

FIGS. 1A-1C illustrate technical components of an exemplary distributed computing environment for automatically and dynamically authenticating users using end-device artificial intelligence 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

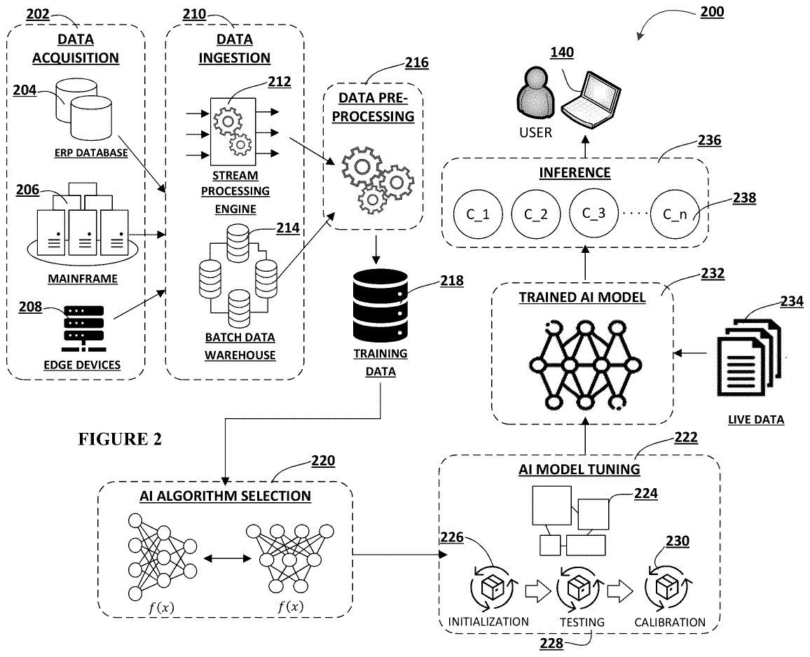

FIG. 2 illustrates an exemplary artificial intelligence (AI) subsystem architecture 200, in accordance with an embodiment of the disclosure. The artificial intelligence subsystem 200 may include a data acquisition engine 202, data ingestion engine 210, data pre-processing engine 216, AI model tuning engine 222, and inference engine 236.

The data acquisition engine 202 may identify various internal and/or external data sources to generate, test, and/or integrate new features for training the artificial intelligence model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence model 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI model tuning engine 222 may be used to train an artificial intelligence model 224 using the training data 218 to make predictions or decisions without explicitly being programmed to do so. The artificial intelligence model 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the artificial intelligence model, the AI model tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained artificial intelligence model 232 is one whose hyperparameters are tuned and model accuracy maximized.

The trained artificial intelligence model 232, similar to any other software application output, can be persisted to storage, file, memory, or application, or looped back into the processing component to be reprocessed. More often, the trained artificial intelligence3 model 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence models that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

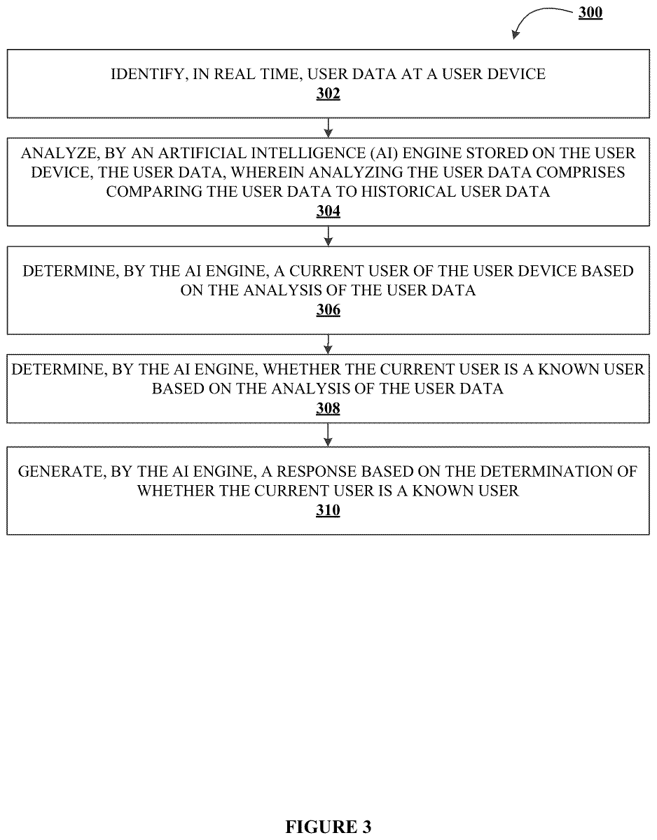

FIG. 3 illustrates a process flow 300 for automatically and dynamically authenticating users using end-device artificial intelligence, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process flow 300. Additionally, and in some embodiments, an AI model (like the AI model shown and described above with respect to FIG. 2) may perform one or more of the steps of process flow 300.

As shown in block 302, the process flow 300 may include the step of identifying, in real time, user data at a user device. In some embodiments, a user device may be any computing device such as, but not limited to, computers, laptops, mobile phones, tablets, and/or the like. User data at the user device may be identified by the user device, by the artificial intelligence engine, or by another application within the user device. User data may comprise information associated with a user. Information associated with a user may comprise, among other things, the personal information of the user, such as, but not limited to, the user's name, birth date, government issued identification number, and/or the like. Information associated with the user may also comprise authentication credentials of the user, such as, but not limited to, the user's username, password, pin, passcode, and/or the like. Further, information associated with the user may comprise information associated with the user's use of the user device, such as telemetry data, and behavioral patterns, such as, but not limited to, the user's typing speed or keystroke patterns. Information associated with the user may also comprise physical characteristics of the user, such as fingerprint identification, facial identification, thermal signature, voice data, and/or the like. User data may comprise geolocation information and thermal readings of the surroundings of the user device. In some embodiments of the disclosure, one or more possible user data elements may be identified. For example, and in some embodiments, all of the user's personal information, physical characteristics, authentication credentials, and geolocation information may be identified. In other embodiments, only the authentication credentials and the physical characteristics may be identified.

In some embodiments, the user data may be identified by at least one of the user device and one or more connected devices. The one or more connected devices may comprise devices associated with a known user. Connected devices may comprise mobile devices or wearable devices, for example. A known user may be a user associated with the user device. For example, and in some embodiments, a known user may be the owner of the user device, i.e., the person to whom the device is registered. In some embodiments, there may be more than one known user to the user device. For example, a home desktop computer may be used by multiple members of the household, with each member having a separate account for the computer. In that case, each member of the household with an account on the computer may be a known user. A device associated with a known user may comprise, for example, may be any device associated with the user's account. For example, a known user to a smart phone (the user device) may wear a smart watch, where both the smart phone and the smart watch are linked to the same account. The smart watch would then be the connected device. The smart watch may identify physical characteristics of the user, such as whether the user is walking, walking speed, and the like.

In some embodiments of the disclosure, the user data is identified in real time. For example, and in some embodiments, this means that all user data is essentially updated constantly. In some embodiments, the user device or the AI engine, at any given moment, have a complete snapshot of all user data associated with the user device and the use of the user device at that moment. In some embodiments of the disclosure, all identified user data is stored temporarily within the AI engine. In some embodiments, the user data is prevented from being transmitted, in any way, out of the AI engine.

As shown in block 304, the process flow 300 may include the step of analyzing, by an artificial intelligence (AI) engine stored on the user device, the user data. In some embodiments of the disclosure, the AI engine analyzes, i.e., processes all the identified user data. In some embodiments of the disclosure, the user data is analyzed in real time. In some embodiments, the user data is identified and analyzed contemporaneously. In some embodiments of the disclosure, analyzing the user data comprises comparing the user data to historical user data. Historical user data may comprise any of the types of user data described above in the description of block 302. Historical user data may comprise all prior user data identified at the user device. In some embodiments, user data is identified in real time and historical user data may comprise user data from just a moment prior. The AI engine may analyze the user data in the context of the historical user data or by comparing the user data to the historical user data. For example, the AI engine may compare the user data with historical user data from a month prior to determine the similarities and differences between the user data and the historical user data, with the end goal of determining a current user of the user device, as described below in the description of block 306. For example, if User A is known user of the user device, the AI engine may consider the user data associated with each of the past times User A used the user device (historical user data) and compare such historical user data to the current user data to determine if the current user is User A. In some embodiments, the AI engine may analyze the user data in the context of historical user data. For example, this may mean that during a specific user session, when the AI engine has already determined that the current user is User A, and when comparing the current user data to the historical user data from the same specific user session lead to some stark difference in characteristics, the AI engine may attribute the difference to an external source and determine that the current user is still User A considering that User A was the user using the user device up until then. However, if the characteristic changes upon multiple such comparisons within the same specific user session, the AI engine may determine that the current user is no longer User A. As a further example, suppose that once the AI engine has determined that the current user of the user session is User A, the AI engine identifies voice data that is not associated with User A. The AI engine may attribute that change to another person in the room and not necessarily that the current user is no longer User A. However, because user data is being identified and analyzed in real time, if the AI engine begins to only identify voice data associated with the other person and no longer identifies voice data associated with User A, the AI engine may determine that the current user may no longer be User A. Practically, however, the AI engine would not likely make the determination based on just one element of the user data but would rather make the determination based on a comprehensive analysis of all available user data considered together.

In some embodiments, there may be no or limited historical user data. For example, there may limited historical user data with respect to a new user device that has not been used before. In that case, in some embodiments, the AI engine may still make a determination based on the limited historical user data. For example, there may be no historical user data associated with the user device, but the user may have had to enter authentication credentials to set up the user device, The AI engine may, in that instance, determine the current user based just on the authentication credentials.

In some embodiments of the disclosure, the AI engine does not store historical user data. Rather, the AI engine is trained, in real time, by the user data identified and analyzed and the determinations made. In some embodiments of the disclosure, the AI engine may store historical user data temporarily. For example, and in some embodiments, the AI engine may store historical user data until the end of a specific user session.

In some embodiments of the disclosure, the AI engine is isolated from other applications within the user device. In some embodiments, the AI engine is protected, such as by encryption, such that it cannot interact with or be accessed by anyone or through any means, including by any other application or software on the user device. In some embodiments, isolation and protection means that all functions of the AI engine occur separately from any other application, software or system. For example, all identified user data is analyzed by the AI engine without any input from any other application or system and the analysis cannot be accessed or intercepted by any other application or system.

As shown in block 306, the process flow 300 may include the step of determining, by the AI engine, a current user of the user device based on the analysis of the user data. A current user of the user device is the individual accessing or using the user device at any given time. In some embodiments of the disclosure, a current user may be an individual who is logged into an account on the user device for a specific user session. The AI engine may determine the current user of the user device based on the analysis of the user data. In some embodiments, the AI engine may determine the current user of the user device in real time. For example, and in some embodiments, the AI engine may identify user data, analyze the user data and determine the current user all in real time for any given moment. Essentially, the AI engine would be continuously monitoring user data to determine the current user of the user device. In some embodiments, for example, the AI engine may determine the current user as described above in the description of block 304. As another example, an individual may unlock a smart phone, beginning a user session. The AI engine, based on the user data from the moment the smart phone is unlocked, may determine who unlocked the phone (e.g., User B unlocked the phone) and continuously monitor user data to reaffirm that User B is the individual using the phone. If User B hands the phone to User A, the AI engine would essentially detect the change in user because it would have been continuously identifying and analyzing user data in real time such that the AI engine would determine when the current user has changed.

In some embodiments of the disclosure, the AI engine may determine if the user data, or any element of the user data, was generated by or using artificial intelligence. For example, the AI engine would be able to determine if an individual tries to use an AI-generated image for facial identification. In some embodiments, the AI engine may be trained to determine AI-generated content. In the example of an AI-generated image being used for facial identification, the AI engine may be trained, for example, to detect anatomical inaccuracies or anomalies in color, texture, or lighting. In some embodiments, upon determining that any element of the user data was generated by AI, the AI engine may discount, i.e., not take into consideration, that particular element in determining the current user.

As shown in block 308, the process flow 300 may include the step of determining, by the AI engine, whether the current user is a known user based on the analysis of the user data. In some embodiments of the disclosure, the AI engine determines whether the current user is the known user in real time. In some embodiments, the AI engine may determine the current user and whether the current user is the known user contemporaneously. A known user is a user associated with the user device. For example, and in some embodiments, the known user is the owner of the user device. In some embodiments, the known user may be a regular user of the user device. In some embodiments, there may be more than one known user for a user device. For example, if multiple members of a household use and have user accounts associated with a home computer, each of the members with a user account may be a known user for the home computer.

In some embodiments of the disclosure, the known user is not only a user known to the user device, but the specific user associated with a user account on the user device. Following the example in the paragraph above, Users A, B, and C may have user accounts on the home computer. If the computer is logged into User A's account, for example, the known user for the user session spanning the time of such log in may only be User A. In such cases, for example, the even though Users B and C are also known users to the user device, the AI engine would only determine that the current user is known if the current user is User A.

In some embodiments of the disclosure, and as described further above, the AI engine may determine that the user data, or one or more elements of the user data, were generated by or using artificial intelligence. In some embodiments, the AI engine may discount the AI-generated elements in determining whether the current user is a known user. In some embodiments, any use of artificial intelligence in user data may lead to the determination that the current user is not the known user. In some embodiments, for example, the AI engine may consider the element of the user data generated by AI to determine that the current user is not a known user. For example, if the individual using the user device has entered the authentication credentials of User A, but used an AI-generated image of User A for facial identification, the AI engine may consider the use of the AI-generated image to determine that the current user is not the known User A.

As shown in block 310, the process flow 300 may include the step of generating, by the AI engine, a response based on the determination of whether the current user is the known user. In some embodiments of the disclosure, the AI engine generates a response in real time and contemporaneous to determining whether the current user is a known user. In some embodiments, the AI engine may only generate a response when there is a need for authentication. For example, if a user is using a note-taking application on an unlocked phone that does not raise significant data security concerns and does not require any kind of authentication, the AI engine may continue to monitor the current user of the user device but may not generate a response. In some embodiments, the AI engine may continuously generate a response but dispose of each response that is not used. For example, the AI engine may in real time just keep updating the response to accurately represent whether, at any given moment, the current user is the known user.

In some embodiments of the disclosure, the response may comprise one of the following responses: yes, no or maybe. The ‘yes’ response is a response that indicates that the current user is the known user. In some embodiments, for example, the ‘yes’ response indicates that the user has been authenticated. The ‘no’ response is a response that indicates that the current user is not the known user. In some embodiments, for example, the ‘no’ response indicates that the user authentication failed, i.e., the current user is definitely not the known user whose identity needs to be verified. The ‘maybe’ response is a response that indicates that the current user may or may not be the known user. In some embodiments, for example, the ‘maybe’ response may indicate that the AI engine did not have adequate data to determine whether the current user is the known user. In some embodiments, the ‘maybe’ response may be a result of one or more elements of the user data being AI-generated.

In some embodiments, this is essentially the user authentication step. The AI engine, based on the analysis of the identified user data determines whether the current user of the user device is the user whose identity is in question. In some embodiments, for example, this may mean ensuring that the user who logs into a user device is the current user throughout the user session. In some embodiments, this may mean ensuring that the user who logs into a particular application on the user device is the current user throughout the user session for that particular application.

In some embodiments of the disclosure, the response triggers one or more actions. One of the one or more actions may comprise launching a secondary authentication method. For example, and in some embodiments, a ‘maybe’ response may trigger a secondary authentication method that relies only on authentication credentials. As another example, the secondary authentication method may comprise multi-factor authentication. In some embodiments, the one or more actions may be related to the purpose for user authentication. For example, if the current user is attempting to initiate a transaction through a bank application on a mobile phone, the AI engine may be authenticating the user to ensure that the current user is the user associated with the bank account (the known user) through which the current user is attempting to initiate the transaction. In that case, a ‘yes’ response may trigger the action of allowing the transaction to go through. A ‘no’ response may trigger cancelling the transaction, alerting the bank, locking the current user out of the account, closing or locking the current user out of the application, and/or the like. The ‘no’ or a ‘maybe’ response may also trigger a secondary authentication method. For example, the ‘no’ or ‘maybe’ response may trigger multifactor authentication. Alternatively, the ‘no’or ‘maybe’ responses may defer to the bank's preferred method of authentication.

In some embodiments of the disclosure, the response may comprise a threat score. A threat score may comprise a range of values, providing more flexibility than the yes, no or maybe response. In some embodiments, a threat score may be, for example, a numerical representation of the level of concern associated with the current user. For example, a score of 0 may indicate the current user is definitely the known user. A score of 100 may indicate that the known user is definitely not the known user. A score of 75 may indicate that some user data indicates that the current user is the known user, but the concern of the current user not being the known user is high. A score of 25 may indicate that most of the user data indicates that the current user is the known user but something is off, giving rise to some concern that the current user is not the known user. For example, a response may comprise a threat score of 25 if most of the user data, such as authentication credentials, physical characteristics and behavioral patterns, indicate that the current user is the known user, but one element of the user data raises a red flag, such as the location of the user device being unknown and far from where the user device was last accessed.

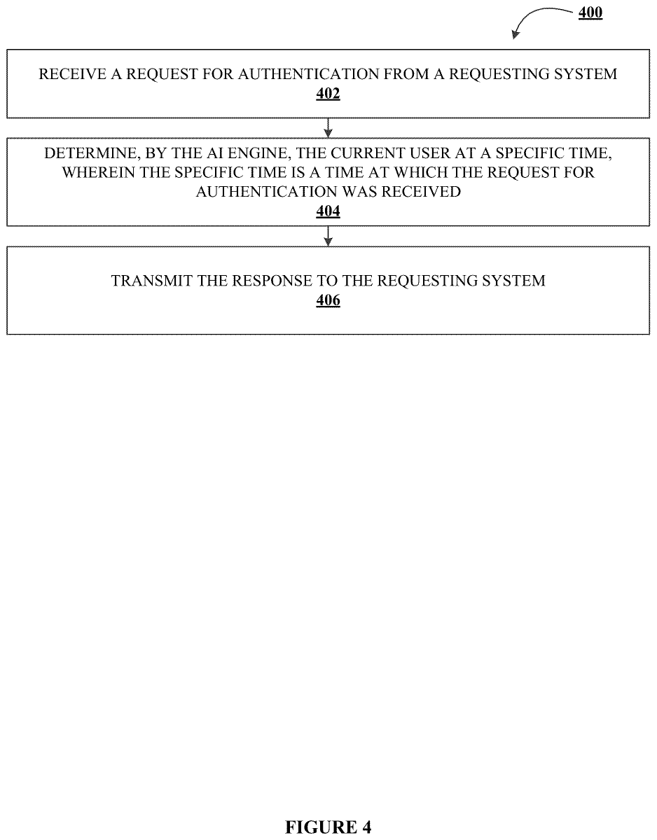

FIG. 4 illustrates a process flow 400 for receiving and responding to requests for authentication, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process flow 400. Additionally, and in some embodiments, an AI model (like the AI model shown and described above with respect to FIG. 2) may perform one or more of the steps of process flow 400.

As shown in block 402, the process flow 400 may include the step of receiving a request for authentication from a requesting system. In some embodiments of the disclosure, the AI engine may receive a request for authentication from a requesting system. A requesting system may be any application, software, server, system, or network that is requesting verification of a particular individual. For example, if a user wants to access the user's bank account via the bank's application on the user's mobile phone (the user device), the bank may request authentication to ensure the user attempting to access the account is in fact the individual associated with the account. In this case, the requesting system may be the bank's application on the mobile phone. In some embodiments, the requesting system is remote from the user device. For example, the request for authentication may come directly from the bank's servers.

As shown in block 404, the process flow 400 may include the step of determining, by the AI engine, the current user at a specific time. The specific time may be a time at which the request for authentication was received. For example, and in some embodiments, upon receiving the request for authorization, the AI engine will complete the authentication process described above in the description of FIG. 3. Upon receiving the request for authentication, the AI engine may analyze the user data at the specific time the request was received, determine the current user at that specific time, and determine whether that current user is the known user.

In some embodiments of the disclosure, the known user may be the individual whose identity the requesting system requested authentication for. For example, in a case where there are multiple known users for a user device, the AI engine may only determine whether the known user whose identity is needs to be verified as the known user for the purposes of authentication. In other words, if the requesting system asks to authenticate if the current user is User A, then the AI engine only determines whether the current user is User A, even if Users B and C are also known users to the user device. In some embodiments, User A may not be a previously known user to the user device. In that case, the AI engine may use information provided by the requesting system as historical user data to determine if the current user is the known user whose identity needs to be verified.

In some embodiments of the disclosure, at the time the request for authentication is received, the AI engine may determine whether the current user is the known user and generate a response indicating the authenticity of the user. For example, and in some embodiments, this essentially means that the AI engine receives a request for authentication that asks “is the current user User A” and upon determination based on the analysis of the user data, the AI engine generates a response to the question of whether the current user is User A. As described above, the response may comprise a response of yes, no, or maybe, a threat score, or both.

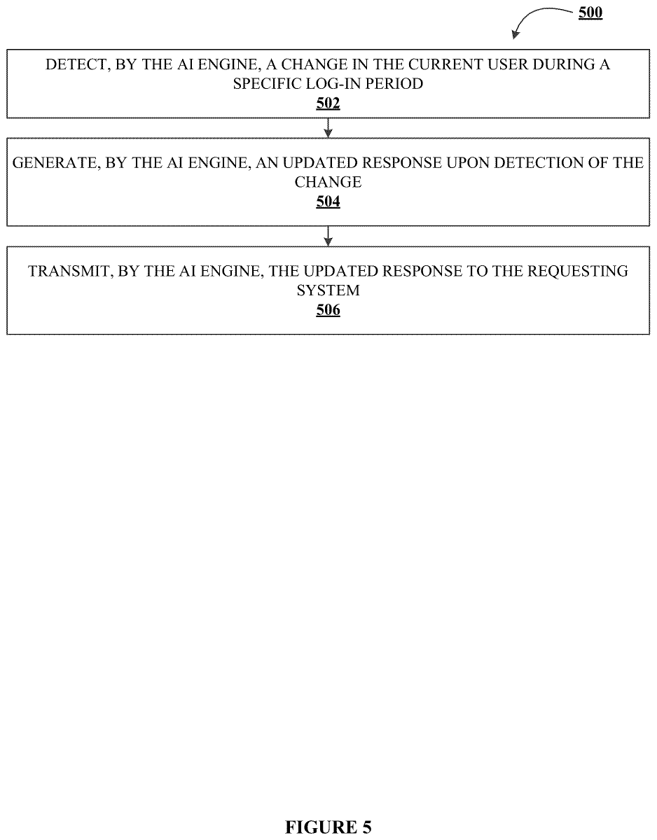

In some embodiments of the disclosure, the AI engine may continue to monitor the current user after generating the response and detect any change in the user after the initial verification at the time of receiving the request, as described further with respect to FIG. 5 below.

As shown in block 406, the process flow 400 may include the step of transmitting the response to the requesting system. In some embodiments of the disclosure, transmitting the response may trigger one or more actions, such as, but not limited to, launching a secondary authentication method. In some embodiments, the requesting system may determine the action to be triggered by the response.

One example of how this may work is as follows. A user opens a bank application on the user's mobile phone to initiate a transaction. The bank sends a request for authentication to ensure the current user attempting to initiate the transaction is the user to whom the bank account is associated. The AI engine verifies the user's identity, as discussed above with respect to FIG. 3. The AI engine may send the bank a response of yes, no or maybe. If the AI engine sends a response of yes, the transaction may automatically be processed. If the AI engine sends a response of no or maybe, the transaction may automatically be cancelled. If the AI engine sends a response of maybe, a secondary authentication method, such as multifactor authentication, may automatically launched. If the AI engine sends a threat score, the bank may determine the certain ranges of score that would trigger automatic processes. For example, the bank may determine that is the threat score indicates 0-5 percent concern, then the transaction should automatically be processed. Alternatively, the bank may receive either the yes, no, or maybe response or the threat score and determine on a case-by-case basis what action to take based on the response it receives.

In some embodiments, crucially, the AI engine can only transmit the response out of the system. In other words, the AI engine cannot transmit the user data, any element or combination of elements of the user data out of the system. Where the AI engine is isolated and protected, ensuring that no user data is transmitted out of the AI engine ensures maximum data security and protection for user data, which may contain personal or sensitive information associated with individuals.

FIG. 5 illustrates a process flow 500 for monitoring for a change in the suer after authentication, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process flow 500. Additionally, and in some embodiments, an AI model (like the AI model shown and described above with respect to FIG. 2) may perform one or more of the steps of process flow 500.

As shown in block 502, the process flow 500 may include the step of detecting, by the AI engine, a change in the current user during a specific log-in period. In some embodiments of the disclosure, the specific log-in period may comprise a user session after the initial verification. For example, if a user is attempting to log-in to a bank application on the user's mobile phone, the bank sends a request for authentication, and the AI engine authenticates the user by sending a ‘yes’ response to the bank, the specific log-in period may be from the moment the user gains access to the application upon authentication until the user logs out of the application or closes the application. In some embodiments, the specific log-in period may comprise the entire time a particular application or function is running. In some embodiments, the specific log-in period may be a specific period of time, such as an hour or a day. In some embodiments, the user may determine the specific log-in period. In some embodiments, the requesting system may determine the specific log-in period.

In some embodiments of the disclosure, the AI engine monitors the current user of the user device throughout the specific log-in period and determines if the current user has changed. For example, the AI engine would be able to determine if another user takes the user's mobile phone after the user was initially verified. The AI engine may monitor the current user by, in real time, analyzing the user data at the user device continuously and determining whether the current user is the known user determined at the point of initial verification.

As shown in block 504, the process flow 500 may include the step of generating, by the AI engine, an updated response upon detection of the change. In some embodiments of the disclosure, the AI engine may update the response indicating whether the current user is the known user based on any detection of change in the current user. The updated response may comprise any of the responses described above, such as yes, no or maybe, or a threat score. Similar to a response triggering one or more actions, an updated response may also trigger one or more actions. For example, if the AI engine determines that the current user is User B after User A is initially verified to log into a certain application and during the same user session, the AI engine may generate the response of ‘no’. The ‘no’ response may trigger the application to close or log the user out. In this way, the user is authenticated continuously, maximizing security. For example, even if a bad actor was able to circumvent the initial authentication, the AI engine would be able to shut the bad actor out as soon as the AI engine determines that the current user is not the authentic user.

As shown in block 506, the process flow 500 may include the step of transmitting, by the AI engine, the updated response to the requesting system. In some embodiments of the disclosure, upon generating an updated response upon detection of a change in user, the AI engine may transmit the updated response to the requesting system that send the initial request for authentication. In some embodiments, the requesting system need not send another request for authentication for the AI engine to transmit the updated response. In some embodiments of the disclosure, the AI engine may automatically transmit the updated response. In some embodiments, upon receiving the updated response, the receiving system may determine the appropriate action to take. In some embodiments, the AI engine may send an updated response at any time from when the initial request for authentication was received until the end of the specific log-in period or user session that was accessed upon authentication of the initial request.

Thus, present embodiments of the disclosure discussed in detail above, the present disclosure provides for automatically and dynamically authenticating users using end-device artificial intelligence to minimize data security concerns. Specifically, the disclosure provides for identifying user data, analyzing the user data, determining a current user of a user device and whether the current user is a known user based on the analysis of the user data, and generating a response based on the determination of whether the current user is a known user. In some embodiments, an AI engine analyzes the user data, determines the current user and whether the current user is a known user, and generates the response. In some embodiments, the user data may be identified via the user device and/or one or more connected devices. In some embodiments, the disclosure further provides for receiving a request for authentication from a requesting system, determining the current user at the time the request is received and transmitting the response to the requesting system. In some embodiments, the requesting system is remote from the user device. In some embodiments, the AI engine detects a change in the current user during a specific log-in period after authentication, generates an updated response upon detection of the change, and transmits the updated response to the requesting system. In some embodiments, one or more actions are triggered based on the response, such as launching a secondary authentication method. In some embodiments, the response comprises one of yes, no, or maybe, and in some embodiments, the response comprises a threat score. In some embodiments of the disclosure, the AI engine is isolated from other applications within the user device and the AI engine can only transmit the response out of the system. In some embodiments of the disclosure, the AI engine determines whether the user data was generated by or using artificial intelligence.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically and dynamically authenticating users using end-device artificial intelligence, the system comprising:
a memory device comprising non-transitory computer-readable medium with computer-readable program code stored thereon;
at least one processing device operatively couples to the at least one memory device and at least one communication device, wherein when executed, the computer-readable code is configured to cause the at least one processing device to:
identify, in real time, user data at a user device;
analyze, by an artificial intelligence (AI) engine stored on the user device, the user data, wherein analyzing the user data comprises comparing the user data to historical user data;
determine, by the AI engine, a current user of the user device based on the analysis of the user data;
determine, by the AI engine, whether the current user is a known user based on the analysis of the user data; and
generate, by the AI engine, a response based on the determination of whether the current user is the known user.

2. The system of claim 1, wherein the computer-readable code is further configured to cause the at least one processing device to:
receive a request for authentication from a requesting system;
determine, by the AI engine, the current user at a specific time, wherein the specific time is a time at which the request for authentication was received; and
transmit the response to the requesting system.

3. The system of claim 2, wherein the requesting system is remote from the user device.

4. The system of claim 1, wherein the system is isolated from other applications within the user device.

5. The system of claim 1, wherein the system can only transmit the response out of the system.

6. The system of claim 1, wherein the computer-readable code is further configured to cause the at least one processing device to determine, by the AI engine, whether the user data was generated by or using artificial intelligence.

7. The system of claim 2, wherein the computer-readable code is further configured to cause the at least one processing device to:
detect, by the AI engine, a change in the current user during a specific log-in period;
generate, by the AI engine, an updated response upon detection of the change; and
transmit, by the AI engine, the updated response to the requesting system.

8. The system of claim 1, the user data is identified via at least one of the user device and one or more connected devices, wherein the one or more connected devices are devices associated with the known user.

9. The system of claim 1, wherein the computer-readable code is further configured to cause the at least one processing device to trigger one or more actions based on the response, wherein one of the one or more actions comprises launching a secondary authentication method.

10. The system of claim 1, wherein the response comprises one of the following responses:
yes, wherein the yes is a response indicating the current user is the known user;
no, wherein the no is a response indicating the current user is not the known user; or
maybe, wherein the maybe is a response indicating the current user may or may not be the known user.

11. The system of claim 1, wherein the response comprises a threat score.

12. A computer implemented method for automatically and dynamically authenticating users using end-device artificial intelligence, the computer implemented method comprising:
identifying, in real time, user data at a user device;
analyzing, by an artificial intelligence (AI) engine stored on the user device, the user data, wherein analyzing the user data comprises comparing the user data to historical user data;
determining, by the AI engine, a current user of the user device based on the analysis of the user data;
determining, by the AI engine, whether the current user is a known user based on the analysis of the user data; and
generating, by the AI engine, a response based on the determination of whether the current user is the known user.

13. The computer implemented method of claim 12, further comprising:
receiving a request for authentication from a requesting system;
determining, by the AI engine, the current user at a specific time, wherein the specific time is a time at which the request for authentication was received; and
transmitting the response to the requesting system.

14. The computer implemented method of claim 12, further comprising determining, by the AI engine, whether the user data was generated by or using artificial intelligence.

15. The computer implemented method of claim 13, further comprising:
detecting, by the AI engine, a change in the current user during a specific log-in period;
generating, by the AI engine, an updated response upon detection of the change; and
transmitting, by the AI engine, the updated response to the requesting system.

16. The computer implemented method of claim 12, further comprising triggering one or more actions based on the response, wherein one of the one or more actions comprises launching a secondary authentication method.

17. A computer program product for automatically and dynamically authenticating users using end-device artificial intelligence, wherein the computer program product comprises at least one non-transitory computer-readable medium having computer-readable program code portions embodied therein, the computer-readable program code portions which when executed by a processing device are configured to cause the processing device to:
identify, in real time, user data at a user device;
analyze, by an artificial intelligence (AI) engine stored on the user device, the user data, wherein analyzing the user data comprises comparing the user data to historical user data;
determine, by the AI engine, a current user of the user device based on the analysis of the user data;
determine, by the AI engine, whether the current user is a known user based on the analysis of the user data; and
generate, by the AI engine, a response based on the determination of whether the current user is the known user.

18. The computer program product of claim 17, wherein the computer-readable program code portions which when executed by a processing device are further configured to cause the processing device to:
receive a request for authentication from a requesting system;
determine, by the AI engine, the current user at a specific time, wherein the specific time is a time at which the request for authentication was received; and
transmit the response to the requesting system.

19. The computer program product of claim 17, wherein the computer-readable program code portions which when executed by a processing device are further configured to cause the processing device to determine, by the AI engine, whether the user data was generated by or using artificial intelligence.

20. The computer program product of claim 18, wherein the computer-readable program code portions which when executed by a processing device are further configured to cause the processing device to:
detect, by the AI engine, a change in the current user during a specific log-in period;
generate, by the AI engine, an updated response upon detection of the change; and
transmit, by the AI engine, the updated response to the requesting system.
